(19) United States
(12) Patent Application Publication
(10) Pub. No.: US 2026/0036917 A1
(43) Pub. Date: Feb. 5, 2026

(54) TONER

(71) Applicant: Sharp Kabushiki Kaisha, Osaka (JP)

(72) Inventor: SHOJI NAKAI, Osaka (JP)

(21) Appl. No.: 19/262,097

(22) Filed: Jul. 8, 2025

(30) Foreign Application Priority Data
Aug. 5, 2024 (JP) 2024-128960

(51) Int. Cl. G03G 9/08; G03G 9/087

(52) U.S. Cl. CPC G03G 9/0827; G03G 9/08755

(57) ABSTRACT

A toner including toner particles containing an amorphous polyester-based resin, a crystalline polyester-based resin, and a wax has the following constitution. The toner particles contain metal oxide particles having a number-average particle size of 60 nm or less. The metal oxide particles are surface-treated with a hydrophobizing agent containing a linear alkyl group having 6 or more carbon atoms. The content of the metal oxide particles in the toner particles is 0.02 mass % or more and 2 mass % or less.

### FIELD OF THE INVENTION

The disclosure relates to a toner.

### BACKGROUND ART

A toner which is used in an electrophotographic image forming apparatus such as a copying machine, a multifunction machine, a printer, or a facsimile apparatus (a toner for developing an electrostatic latent image) generally has a constitution in which an external additive adheres to the surfaces of toner particles (toner cores).

In recent years, further energy saving is desired in image forming apparatuses, and to realize such energy saving, low-temperature fixability is required for toners. A toner containing a crystalline polyester-based resin in toner particles to enhance low-temperature fixability is known.

In addition, to continue to form images having a stable quality, a toner desirably has a stable charging property throughout its life (product life). To stabilize the charging property of the toner over a long period of time, it is effective to internally add a charge control agent to toner particles or externally add metal oxide particles surface-treated with a hydrophobizing agent to the surfaces of the toner particles. Note that in the disclosure, “externally added” means that an additive is added so as to adhere to the outer surface (surface) of an additive-receiving material, and “internally added” means that an additive is added so as to be contained inside an additive-receiving material.

### SUMMARY

### Technical Problem

However, even if a macroscopic charge amount is stabilized by externally adding the metal oxide particles surface-treated with the hydrophobizing agent to the surfaces of the toner particles, there is a problem that a charge amount distribution becomes non-uniform (broad) as the life progresses due to burying of the external additive in the surfaces of the toner particles or carrier contamination of the external additive, leading to deterioration of fogging.

In addition, when toner particles contain a crystalline polyester-based resin, the melting temperature of the toner is lowered and fixing at a lower temperature becomes possible; however, there are problems that hot offset is likely to occur, and durability of the toner is lowered, which makes the external additive likely to be embedded in the surfaces of the toner particles, leading to a decrease in uniformity of the image density.

The content of the disclosure has been found in view of such circumstances in a toner that can be fixed at a low temperature with toner particles containing a crystalline polyester-based resin, and a main object thereof is to provide a toner that has sufficient hot offset resistance and can suppress occurrence of fogging and a decrease in uniformity of an image density over a long period of time.

### Solution to Problem

A toner of the disclosure made to solve the above problems is a toner having toner particles including an amorphous polyester-based resin, a crystalline polyester-based resin, and a wax, in which the toner particles include metal oxide particles having a number-average particle size of 60 nm or less, the metal oxide particles are surface-treated with a hydrophobizing agent containing a linear alkyl group having 6 or more carbon atoms, and a content of the metal oxide particles in the toner particles is 0.02 mass % or more and 2 mass % or less.

In the toner described above, the metal oxide particles are preferably titanium oxide particles.

In the toner described above, the shape of each of the metal oxide particles is preferably a needle shape.

In the toner described above, the linear alkyl group contained in the hydrophobizing agent preferably has 10 or less carbon atoms.

In the toner described above, a hydrophobicity of the metal oxide particles is preferably 40% or more and 80% or less.

In the toner described above, the amorphous polyester-based resin preferably has an SP value of 10.85 or more and 11.3 or less, and the crystalline polyester-based resin preferably has an SP value of 9.4 or more and 9.8 or less.

In the toner described above, when the content of the metal oxide particles in the toner particles is defined as A mass % and the content of the crystalline polyester-based resin in the toner particles is defined as B mass %, the mass ratio A/B is preferably 0.003 or more and 0.4 or less.

In the toner described above, the wax is preferably an ester wax.

Note that Patent Document 1 discloses that in an image forming apparatus having a toner image fixing unit, which is a specific structure, a toner in which inorganic particles having an average particle size of 5 nm to 1000 nm are internally added to toner particles including a crystalline polyester-based resin and an amorphous polyester-based resin is used. However, it is not disclosed that metal oxide particles surface-treated with a hydrophobizing agent containing a linear alkyl group as described above are used, and the toner constitution disclosed in Patent Document 1 cannot sufficiently enhance dispersibility of the crystalline polyester-based resin included in the toner particles, which cannot solve the problems described above according to the disclosure.

### Advantageous Effects of Disclosure

According to the toner of the disclosure, the toner particles contain a crystalline polyester-based resin, and thus excellent effects such as sufficient hot offset resistance while being capable of low-temperature fixing, suppression of occurrence of fogging over a long period of time, and suppression of a decrease in uniformity of an image density over a long period of time are exhibited.

### BRIEF DESCRIPTION OF THE DRAWINGS

FIG. 1 is a cross-sectional view schematically illustrating a dispersion state of constituent components in a toner particle according to a present embodiment.

FIG. 2 is a conceptual diagram of an interaction between a metal oxide particle surface-treated with a hydrophobizing agent and an amorphous portion of a crystalline polyester-based resin.

### DETAILED DESCRIPTION OF THE INVENTION

The toner of the disclosure will be described in detail below.

### 1. Toner Particles (Toner Cores)

Toner particles according to a present embodiment has a constitution including, as binder resins, at least an amorphous polyester-based resin, a crystalline polyester-based resin, and a wax, and may contain an optional component as long as the effect of the disclosure is not impaired. The volume-average particle size of the toner particles can be appropriately selected depending on the intended purpose and is, for example, 4 μm or more and 8 μm or less.

The toner particles according to the present embodiment further contain metal oxide particles. The metal oxide particles have a number-average particle size of 60 nm or less and are surface-treated with a hydrophobizing agent containing a linear alkyl group having 6 or more carbon atoms.

Here, a description will be given of a presumed mechanism in which the toner according to the present embodiment has sufficient hot offset resistance and is capable of suppressing occurrence of image defects (occurrence of fogging and a decrease in uniformity of an image density) over a long period of time.

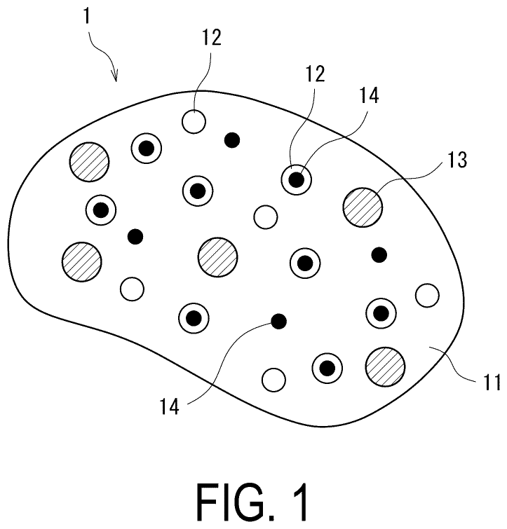

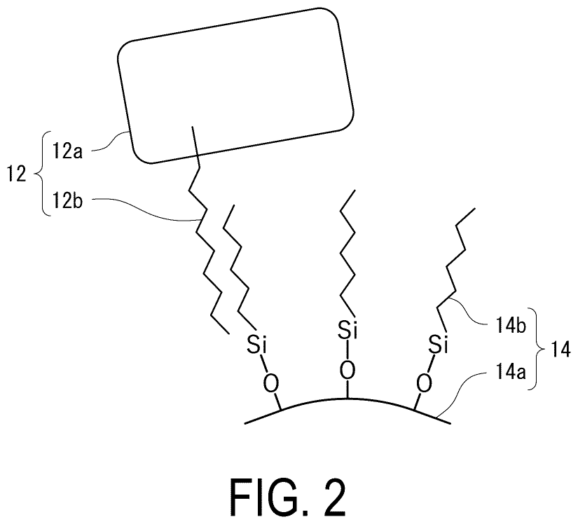

FIG. 1 is a cross-sectional view schematically illustrating a dispersion state of constituent components in a toner particle according to the present embodiment, and FIG. 2 is a conceptual diagram of an interaction between a metal oxide particle surface-treated with a hydrophobizing agent and an amorphous portion of a crystalline polyester-based resin.

As illustrated in FIG. 2, a metal oxide particle 14 has a structure in which a base body 14a of the metal oxide particle (main body of the metal oxide particle) is surface-treated with a hydrophobizing agent 14b containing a linear alkyl group having 6 or more carbon atoms. A crystalline polyester-based resin 12 has a structure having a crystalline portion 12a and an amorphous portion 12b. A hydrophobic interaction between the linear alkyl group of the hydrophobizing agent 14b present on the surface of the metal oxide particle 14 and the amorphous portion 12b present at an end of the crystalline polyester-based resin 12 makes the crystalline polyester-based resin 12 easy to be present around the metal oxide particle 14. This facilitates the transfer of a charge between the amorphous portion 12b and the hydrophobizing agent 14b, which makes charge retention and charge transfer in the toner particle less likely to be affected by the environmental influence and the influence of an external additive embedded in the surface of the toner particle. As a result, the charging performance of the toner is improved throughout its life, and the occurrence of fogging is suppressed over a long period of time.

Furthermore, as illustrated in FIG. 1, the crystalline polyester-based resin 12 is distributed in an amorphous polyester-based resin 11 of the toner particle 1 so as to surround the metal oxide particle 14, and the crystalline polyester-based resin 12 is easily crystallized by a hydrophobic interaction with the hydrophobizing agent 14b on the surface of the metal oxide particle 14. This improves heat-resistant preservability of the toner particle 1 and prevents an external additive from being embedded in the surface of the toner particle 1. As a result, the decrease in uniformity of an image density is suppressed for a long period of time.

When the metal oxide particle 14 is present in the toner particle 1, the crystalline polyester-based resin 12 is in a more finely dispersed state in the toner particle 1, and the metal oxide particle 14 acts as a filler, and thus, there is a possible adverse effect of inhibiting the low-temperature fixability. However, the adverse effect is canceled by the presence of the crystalline polyester-based resin 12 on the surface of the metal oxide particle 14, and thus, a fixable region of the toner is expanded. That is, the toner can be fixed at a low temperature and has sufficient hot offset resistance.

Next, constituent components of the toner particles according to the present embodiment will be described.

### Polyester-Based Resin

The toner particles according to the present embodiment include, as binder resins, at least an amorphous polyester-based resin and a crystalline polyester-based resin. When the crystalline polyester-based resin is added, it is possible to lower the softening temperature and the melt viscosity of the toner. In other words, when the toner particles in which the amorphous polyester-based resin and the crystalline polyester-based resin are used in combination are used, it is possible to obtain a toner having improved low-temperature fixability.

An SP value (solubility parameter) of the amorphous polyester-based resin contained in the toner particles according to the present embodiment is preferably 10.85 or more and 11.3 or less, and an SP value of the crystalline polyester-based resin is preferably 9.4 or more and 9.8 or less. When the SP values of both the resins are set to fall within the above ranges, a compatible state of both the resins becomes optimal, which can enhance durability of the toner while maintaining excellent low-temperature fixability. More preferably, the SP value of the amorphous polyester-based resin is 11 or more and 11.2 or less, and the SP value of the crystalline polyester-based resin is 9.5 or more and 9.65 or less. Note that the unit of the SP value in the disclosure is (cal/cm³)^{1/2}.

In a case where the SP value of the amorphous polyester-based resin is less than the lower limit, the compatibility with the crystalline polyester-based resin may be enhanced, and the durability of the toner may be reduced, whereby the uniformity of the image density may be decreased. In a case where the SP value of the amorphous polyester-based resin exceeds the upper limit, the compatibility with the crystalline polyester-based resin may be reduced, and the dispersibility in the toner particles may be deteriorated, whereby the hot offset resistance may be deteriorated. In a case where the SP value of the crystalline polyester-based resin is less than the lower limit, the compatibility with the amorphous polyester-based resin may be reduced, and the dispersibility in the toner particles may be deteriorated, whereby the hot offset resistance may be deteriorated. In a case where the SP value of the crystalline polyester-based resin exceeds the upper limit, the compatibility with the amorphous polyester-based resin may be enhanced, the durability of the toner may be decreased, whereby the uniformity of the image density may be decreased.

In the disclosure, the amorphous resin and the crystalline resin are distinguished by a crystallinity index. Resins having a crystallinity index in a range from 0.6 to 1.5 are classified as crystalline resins, and resins having a crystallinity index less than 0.6 or greater than 1.5 are classified as amorphous resins. Resins having a crystallinity index greater than 1.5 are amorphous, and resins having a crystallinity index less than 0.6 have low crystallinity and many amorphous parts.

The crystallinity index is an indicator of the degree of crystallinity of the resin and is defined by the ratio of the softening temperature to the maximum endothermic peak temperature (softening temperature/maximum endothermic peak temperature). Here, the maximum endothermic peak temperature refers to the temperature of the peak on the highest temperature side among the endothermic peaks observed. In the crystalline polyester-based resin, the maximum peak temperature is used as the melting point, and in the amorphous polyester-based resin, the peak on the highest temperature side is used as the glass transition temperature.

The degree of crystallinity of the resin can be controlled by adjusting the types and ratios of monomers from which the resin is produced, production conditions (e.g., reaction temperature, reaction time, and cooling rate), and the like.

### Amorphous Polyester-Based Resin

The amorphous polyester-based resin contained in the toner particles according to the present embodiment is obtained by, for example, a polycondensation reaction between a carboxylic acid monomer including terephthalic acid or isophthalic acid as a main component and a polyhydric alcohol including ethylene glycol as a main component.

The dicarboxylic acid monomer used for synthesis of the amorphous polyester-based resin includes terephthalic acid or isophthalic acid as a main component. The molar content of terephthalic acid or isophthalic acid in the dicarboxylic acid monomer is preferably in a range from 70% to 100%, and more preferably in a range from 80% to 100%.

Furthermore, the dicarboxylic acid monomer may include an aromatic dicarboxylic acid or an aliphatic dicarboxylic acid other than terephthalic acid and isophthalic acid. Examples of the aromatic dicarboxylic acid other than terephthalic acid and isophthalic acid include fumaric acid. Examples of the aliphatic dicarboxylic acid include adipic acid, sebacic acid, and succinic acid. The dicarboxylic acid monomer may include an ester-forming derivative of terephthalic acid or isophthalic acid, an ester-forming derivative of an aromatic dicarboxylic acid other than terephthalic acid and isophthalic acid, an ester-forming derivative of an aliphatic dicarboxylic acid, or the like. In the disclosure, ester-forming derivatives include carboxylic acid anhydrides, alkyl esters, and the like. One of these dicarboxylic acid monomers may be used individually, or two or more may be used in combination.

In the synthesis of the amorphous polyester-based resin, a polycarboxylic acid monomer containing three or more carboxyl groups may be used together with the dicarboxylic acid monomer described above. As the polycarboxylic acid monomer containing three or more carboxyl groups, a polycarboxylic acid containing three or more carboxyl groups such as trimellitic acid and pyromellitic acid and an ester-forming derivative thereof can be used. One of these polycarboxylic acid monomers containing three or more carboxyl groups may be used individually, or two or more may be used in combination.

The diol monomer used for synthesis of the amorphous polyester-based resin includes ethylene glycol as a main component. Here, the molar content of ethylene glycol in the diol monomer is preferably in a range from 70% to 100%, and more preferably in a range from 80% to 100%.

The diol monomer may include 1,3-propylene glycol, 1,4-butanediol, and the like. One of these diol monomers may be used individually, or two or more may be used in combination.

The amorphous polyester-based resin used in the toner according to the present embodiment can be produced in a manner similar to a common polyester production method. For example, the amorphous polyester-based resin can be synthesized by a polycondensation reaction using a dicarboxylic acid monomer and a polyhydric alcohol, and optionally a polycarboxylic acid monomer containing three or more carboxyl groups, in a temperature range from 190° C. to 240° C. in a nitrogen gas atmosphere. In the polycondensation reaction, the reaction ratio between the diol monomer and the carboxylic acid monomer (including the dicarboxylic acid monomer and, if used, the polycarboxylic acid monomer containing three or more carboxyl groups) is preferably from 1.3:1 to 1:1.2, in terms of [OH]:[COOH] which is the equivalent ratio between the hydroxyl group and the carboxyl group. In the polycondensation reaction, the molar content of the dicarboxylic acid monomer in the carboxylic acid monomer is preferably from 80% to 100%. In the polycondensation reaction, an esterification catalyst such as dibutyltin oxide or titanium alkoxide (for example, tetrabutoxy titanate) may be further used if necessary.

The content of the amorphous polyester-based resin in the toner particles according to the present embodiment is preferably 60 mass % or more and 95 mass % or less and more preferably 70 mass % or more and 90 mass % or less.

### Crystalline Polyester-Based Resin

In the toner particles according to the present embodiment, the crystalline polyester-based resin is dispersed in the amorphous polyester-based resin. The crystalline polyester-based resin is preferably composed of a linear saturated aliphatic polyester unit obtained by polycondensation between a carboxylic acid monomer including an aliphatic dicarboxylic acid having 9 to 22 carbon atoms as a main component and a polyhydric alcohol including an aliphatic diol having 2 to 10 carbon atoms as a main component. The crystalline polyester-based resin composed of the linear saturated aliphatic polyester unit lowers the compatibility between the crystalline polyester-based resin and the amorphous polyester-based resin.

The dicarboxylic acid monomer used for synthesis of the crystalline polyester-based resin includes an aliphatic dicarboxylic acid having 9 to 22 carbon atoms as a main component. Here, the molar content of the aliphatic dicarboxylic acid having 9 to 22 carbon atoms in the dicarboxylic acid monomer is preferably in a range from 80% to 100%.

Examples of the aliphatic dicarboxylic acid having 9 to 22 carbon atoms include azelaic acid, sebacic acid, dodecanedioic acid, and 1,18-octadecanedicarboxylic acid. The dicarboxylic acid monomer may also include an ester-forming derivative of any of these aliphatic dicarboxylic acids. One of these dicarboxylic acid monomers may be used individually, or two or more may be used in combination.

In the synthesis of the crystalline polyester-based resin, a polycarboxylic acid monomer containing three or more carboxyl groups may be used together with the dicarboxylic acid monomer described above. As the polycarboxylic acid monomer containing three or more carboxyl groups, a polycarboxylic acid containing three or more carboxyl groups such as trimellitic acid and pyromellitic acid and an ester-forming derivative thereof can be used. One of these polycarboxylic acid monomers containing three or more carboxyl groups may be used individually, or two or more may be used in combination.

The diol monomer used for synthesis of the crystalline polyester-based resin includes an aliphatic diol having 2 to 10 carbon atoms as a main component. Here, the molar content of the aliphatic diol having 2 to 10 carbon atoms in the diol monomer is preferably in a range from 80% to 100%.

Examples of the aliphatic diol having 2 to 10 carbon atoms include ethylene glycol, 1,4-butanediol, 1,6-hexanediol, 1,9-nonanediol, and 1,10-decanediol. One of these diol monomers may be used individually, or two or more may be used in combination.

In the synthesis of the crystalline polyester-based resin, a polyol monomer containing three or more hydroxyl groups may be used together with the diol monomer. As the polyol monomer containing three or more hydroxyl groups, glycerol, trimethylolpropane and the like can be used. One of these polyol monomers containing three or more hydroxyl groups may be used individually, or two or more may be used in combination.

The crystalline polyester-based resin used in the toner according to the present embodiment can be produced in a manner similar to a common polyester production method. For example, the crystalline polyester-based resin can be synthesized by a polycondensation reaction using a dicarboxylic acid monomer and a diol monomer, and optionally a polycarboxylic acid monomer containing three or more carboxyl groups or a polyol monomer containing three or more hydroxyl groups, in a temperature range from 190° C. to 240° C. in a nitrogen gas atmosphere.

In the above-described polycondensation reaction, the equivalent ratio of the hydroxyl group of the polyol monomer (including the diol monomer and optionally the polyol monomer containing three or more hydroxyl groups) to the carboxyl group of the carboxylic acid monomer (including the dicarboxylic acid monomer and optionally the polycarboxylic acid monomer containing three or more carboxyl groups) (OH group/COOH group) is preferably in a range from 0.83 to 1.3, from the viewpoint of storage stability and the like.

In the above-described polycondensation reaction, the molar content of the dicarboxylic acid monomer in the carboxylic acid monomer is preferably from 90% to 100%. Lower molar content of the dicarboxylic acid monomer results in decrease in the level or rate of crystallization, and insufficient toner aggregation resistance (a tendency of the toner to resist aggregating).

Furthermore, in the polycondensation reaction, the molar content of the diol monomer in the polyol monomer is preferably in a range from 80% to 100%. Note that in the polycondensation reaction, an esterification catalyst such as dibutyltin oxide or titanium alkoxide (for example, tetrabutoxy titanate) may be used if necessary.

The content of the crystalline polyester-based resin in the toner particles according to the present embodiment is preferably 2 mass % or more and 10 mass % or less and more preferably 4 mass % or more and 8 mass % or less.

### Metal Oxide Particles

The metal oxide particles contained in the toner particles according to the present embodiment have a number-average particle size of 60 nm or less and are surface-treated with a hydrophobizing agent containing a linear alkyl group having 6 or more carbon atoms.

As the base body of the metal oxide particles, titanium oxide, alumina, zinc oxide, tin oxide, cesium oxide, or the like can be used. These can exert a function of controlling conductivity of the toner particles. One of these base bodies may be used individually, or two or more thereof may be used in combination. Among these, titanium oxide is preferably used.

The method of producing the base body of the metal oxide particles is not particularly limited, but as a method of producing rutile-type titanium oxide particles, for example, there is a method described in JP 2001-26423 A, that is, a method in which an aqueous solution of titanium tetrachloride is hydrolyzed to prepare a fine titania sol having a rutile nucleus, and the sol is separated and then heat-treated to obtain titanium oxide particles. As a method of producing anatase-type titanium oxide particles, for example, there is a method described in JP 2000-10335 A, that is, a method in which a solution obtained by dissolving a raw material such as ilmenite ore in sulfuric acid is hydrolyzed, granulated, dried, and then calcined at a high temperature to obtain titanium oxide particles.

The shape of each of the metal oxide particles used in the toner according to the present embodiment is preferably a needle shape. Here, the needle shape refers to a shape having an aspect ratio (major axis/minor axis) of 4.0 or more. The aspect ratio is more preferably 6.0 or more. In a case where the shape of each of the metal oxide particles is a needle shape, the specific surface area of the metal oxide particles increases and the contact interface with the crystalline polyester-based resin increases, as compared with a case where the shape is spherical. This makes it possible to make the charge amount distribution of the toner uniform and suppress the occurrence of fogging. In addition, fixing inhibition due to a filler effect of the metal oxide particles is less likely to occur during toner fixing, and thus the hot offset resistance is improved. The upper limit of the aspect ratio is not particularly limited, but is preferably 20.0 or less, and more preferably 15.0 or less, from the viewpoint of easily producing particles having a suitable particle size.

Examples of the needle-shaped metal oxide particles include needle-shaped titanium oxide particles. The needle-shaped titanium oxide particles can be obtained by, for example, as in Examples described below, calcining a mixture of spherical rutile-type titanium oxide particles and sodium pyrophosphate decahydrate, putting the calcined product into pure water to be heated, and washing the calcined product after heating to remove soluble salts.

The number-average particle size of the metal oxide particles used in the toner according to the present embodiment is 60 nm or less, more preferably 10 nm or more and 50 nm or less, and even more preferably 20 nm or more and 45 nm or less. In a case where the number-average particle size of the metal oxide particles exceeds the upper limit, a conductive path formed by the metal oxide particles in the toner particles increases, and thus fogging may be deteriorated. When the number-average particle size of the metal oxide particles is within the above range, a conductive path having a preferable size is formed in the toner particles.

The metal oxide particles used in the toner according to the present embodiment are surface-treated with a hydrophobizing agent including a linear alkyl group having 6 or more carbon atoms, and the number of carbon atoms of the linear alkyl group included in the hydrophobizing agent is 6 or more and 12 or less, preferably 6 or more and 10 or less, and more preferably 8.

In a case where the number of carbon atoms of the linear alkyl group in the hydrophobizing agent is less than 6, the hydrophobic interaction with the amorphous portion present in the molecule of the crystalline polyester-based resin does not sufficiently work, the crystalline polyester-based resin is hardly distributed around the metal oxide particles, and the dispersibility of the crystalline polyester-based resin deteriorates. As a result, the hot offset resistance of the toner may deteriorate, or the durability of the toner may decrease, resulting in a decrease in uniformity of an image density.

In a case where the number of carbon atoms of the linear alkyl group in the hydrophobizing agent exceeds the upper limit, metal oxides are easily coalesced with each other through the hydrophobizing agent, thereby decreasing the specific surface area of the metal oxide particles. When the specific surface area of the metal oxide particles is small, the contact interface with the crystalline polyester-based resin is reduced, and thus the charge amount distribution of the toner becomes non-uniform, and as a result, fogging may be deteriorated or hot offset resistance may be deteriorated.

In a case where the alkyl group in the hydrophobizing agent is not linear, the effect of increasing the crystallinity of the crystalline polyester-based resin distributed around the metal oxide particles is weakened, and thus the hot offset resistance may be deteriorated, or the durability of the toner may be lowered, resulting in a decrease in uniformity of the image density.

As the hydrophobizing agent for surface treatment of the metal oxide particles used in the toner according to the present embodiment, a hydrophobizing agent which may have a structure including a linear alkyl group having 6 or more carbon atoms may be adopted, and examples thereof include a silane coupling agent. Examples of the silane coupling agent including a linear alkyl group having 6 or more carbon atoms include trimethoxysilane to which a linear alkyl group is bonded, and a suitable range of the number of carbon atoms of the linear alkyl group is as described above. The method of surface treatment of the metal oxide particles with the hydrophobizing agent is not particularly limited, but for example, as in Examples described below, the metal oxide particles surface-treated with the hydrophobizing agent can be obtained by stirring and mixing a solvent to which the metal oxide particles and the hydrophobizing agent are added, distilling off the solvent, heating the resultant, and crushing the heated product.

In the toner according to the present embodiment, the hydrophobicity of the metal oxide particles surface-treated with the hydrophobizing agent is preferably 40% or more and 80% or less, and more preferably 60% or more and 75% or less. In a case where the hydrophobicity of the metal oxide particles is less than the lower limit, formation of the conductive path by the metal oxide particles may be excessive, and the charge amount of the toner may decrease, resulting in a deterioration in fogging. In a case where the hydrophobicity of the metal oxide particles exceeds the upper limit, the formation of the conductive path by the metal oxide particles may be insufficient, and the charge amount distribution of the toner may be non-uniform, resulting in deterioration in fogging.

The content of the metal oxide particles in the toner particles according to the present embodiment is 0.02 mass % or more and 2 mass % or less, more preferably 0.02 mass % or more and 0.5 mass % or less, and even more preferably 0.03 mass % or more and 0.1 mass % or less. In a case where the content of the metal oxide particles in the toner particles is less than the lower limit, the formation of the conductive path by the metal oxide particles is insufficient, and the effect of enhancing the dispersibility of the crystalline polyester-based resin is insufficient. As a result, the charge amount distribution of the toner may be non-uniform, the hot offset resistance may be deteriorated, and the uniformity of the image density may decrease. In a case where the content of the metal oxide particles in the toner particles exceeds the upper limit, the formation of the conductive path by the metal oxide particles may be excessive, and the charge amount of the toner may decrease, resulting in deterioration of fogging.

When the content of the metal oxide particles in the toner particles according to the present embodiment is defined as A mass % and the content of the crystalline polyester-based resin is defined as B mass %, a mass ratio A/B is preferably 0.003 or more and 0.4 or less, more preferably 0.003 or more and 0.1 or less, even more preferably 0.005 or more and 0.05 or less, and particularly preferably 0.007 or more and 0.02 or less.

In a case where the mass ratio A/B is less than the lower limit, a volume of the metal oxide particles relative to a volume of the crystalline polyester-based resin in the toner particles is insufficient, and domains of the crystalline polyester-based resin present in contact with the metal oxide particles are reduced. This may weaken the effect of increasing the crystallinity of the crystalline polyester-based resin, which is caused by the contact between the metal oxide particles and the crystalline polyester-based resin, and may reduce the durability of the toner.

In a case where the mass ratio A/B exceeds the upper limit, the volume of the metal oxide particles relative to the volume of the crystalline polyester-based resin in the toner particles is excessive, and the metal oxide particles present in contact with the crystalline polyester-based resin are reduced. This makes the charging property of the toner unstable, and fogging may be deteriorated. In addition, the filler effect of the metal oxide particles is likely to be exhibited, and the hot offset resistance may be deteriorated.

The metal oxide particles used in the toner particles according to the present embodiment are preferably subjected to a treatment of forming a conductive layer on the surface thereof before the surface treatment with the hydrophobizing agent described above. That is, the metal oxide particles included in the toner particles according to the present embodiment are preferably metal oxide particles having a conductive layer formed on the surface thereof, which are surface-treated with the hydrophobizing agent described above. Examples of the conductive layer include a conductive layer of aluminum oxide, and examples of the method of forming the conductive layer include a method of dispersing metal oxide particles in an aqueous solution of sodium aluminate.

### Wax

The toner particles according to the present embodiment contain a wax as a release agent. Examples of the wax include an ester wax, a paraffin wax, a Fischer-Tropsch wax, a carnauba wax, and a montan wax. One of these waxes may be used individually, or two or more thereof may be used in combination.

Among these, an ester wax is more preferable. When the ester wax is used as the wax internally added to the toner particles, the dispersibility of the crystalline polyester-based resin and the amorphous polyester-based resin is improved, and the durability of the toner is improved. In addition, a polar group of the ester wax functions to optimize the charge amount distribution of the toner, thereby suppressing the occurrence of fogging.

The ester wax to be used is not particularly limited, but is preferably an ester of a monohydric alcohol and a monocarboxylic acid, an ester of an alcohol having 4 or more and 8 or less hydroxyl groups and an aliphatic monocarboxylic acid, or an ester of a carboxylic acid having 4 or more and 8 or less carboxyl groups and an aliphatic monoalcohol. Examples of the ester wax include the following:
esters of a monohydric alcohol and a monocarboxylic acid, such as behenyl behenate, stearyl stearate, and palmityl palmitate;
esters of a divalent carboxylic acid and a monoalcohol, such as dibehenyl sebacate;
esters of a dihydric alcohol and a monocarboxylic acid, such as ethylene glycol distearate and hexanediol dibehenate;
esters of a trihydric alcohol and a monocarboxylic acid, such as glycerin tribehenate;
esters of a tetrahydric alcohol and a monocarboxylic acid, such as pentaerythritol tetrastearate and pentaerythritol tetrapalmitate;
esters of a hexahydric alcohol and a monocarboxylic acid, such as dipentaerythritol hexastearate, dipentaerythritol hexapalmitate, and dipentaerythritol hexabehenate;
esters of a polyfunctional alcohol and a monocarboxylic acid, such as polyglycerol behenate; and
natural ester waxes such as carnauba wax and rice wax.

Among these, esters of a hexahydric alcohol and a monocarboxylic acid, such as dipentaerythritol hexastearate, dipentaerythritol hexapalmitate, and dipentaerythritol hexabehenate, are preferable.

The melting point of the ester wax is preferably 60° C. or higher and 90° C. or lower and more preferably 65° C. or higher and 85° C. or lower. The SP value of the ester wax is preferably 8.30 or more and 9.10 or less and more preferably 8.45 or more and 8.95 or less.

The content of the wax in the toner particles is preferably 0.5 mass % or more and 10 mass % or less, and more preferably 2 mass % or more and 5 mass % or less.

### Colorant

The toner particles according to the present embodiment may include a colorant. As the colorant, organic pigments, organic dyes, inorganic pigments, inorganic dyes, and the like used in the field of electrophotography can be used.

Examples of a black colorant include carbon black, copper oxide, manganese dioxide, aniline black, activated carbon, nonmagnetic ferrite, magnetic ferrite, and magnetite.

Examples of a yellow colorant include C.I. Pigment Yellow 12, C.I. Pigment Yellow 13, C.I. Pigment Yellow 14, C.I. Pigment Yellow 15, C.I. Pigment Yellow 17, C.I. Pigment Yellow 74, C.I. Pigment Yellow 93, C.I. Pigment Yellow 94, C.I. Pigment Yellow 138, C.I. Pigment Yellow 180, and C.I. Pigment Yellow 185.

Examples of a magenta colorant include C.I. Pigment Red 48:1, C.I. Pigment Red 53:1, C.I. Pigment Red 57:1, C.I. Pigment Red 122, C.I. Pigment Red 123, C.I. Pigment Red 139, C.I. Pigment Red 144, C.I. Pigment Red 149, C.I. Pigment Red 166, C.I. Pigment Red 177, C.I. Pigment Red 178, and C.I. Pigment Red 222.

Examples of a cyan colorant include C.I. Pigment Blue 15, C.I. Pigment Blue 15:2, C.I. Pigment Blue 15:3, C.I. Pigment Blue 16, and C.I. Pigment Blue 60.

The content of the colorant in the toner particles is preferably in a range from 3 parts by mass to 10 parts by mass. Note that to uniformly disperse the colorant in the binder resin, the colorant may be used in the form of masterbatch.

### Charge Control Agent

The toner particles according to the present embodiment may contain a charge control agent. The charge control agent is added to impart a preferable charging property to the toner. The charge control agent is not particularly limited, and charge control agents for positive charge control and negative charge control used in the field of electrophotography can be used.

Examples of a charge control agent for positive charge control include quaternary ammonium salts, pyrimidine compounds, triphenylmethane derivatives, guanidine salts, and amidine salts.

Examples of a charge control agent for negative charge control include metal-containing azo compounds, azo complex dyes, metal complexes and metal salts of salicylic acid and derivatives thereof (the metal is chromium, zinc, zirconium, or the like), organic bentonite compounds, and boron compounds.

One of these charge control agents may be used individually, or two or more thereof may be used in combination. The content of the charge control agent in the toner particle is preferably in a range from 0.5 mass % to 5 mass %.

### External Additive

In the toner according to the present embodiment, an external additive may adhere to the surfaces of the toner particles described above. Examples of the function of the external additive include a function of enhancing powder fluidity, triboelectric chargeability, heat-resistant storage capability, and cleaning characteristics of the toner, a function of controlling abrasion characteristics of the surface of the photoreceptor, and the like.

Examples of the external additive that can be used include inorganic particles such as silica and titanium oxide having an average particle size of 7 nm or more and 200 nm or less. Inorganic particles to which hydrophobicity is imparted by subjecting the surfaces of these inorganic particles to surface treatment with a hydrophobizing agent such as a silane coupling agent, a titanium coupling agent, or silicone oil are suitable because the decrease in electric resistance and charge amount in a high-humidity environment is small.

Examples of the silica particles as the external additive include silica particles commonly used in the art, for example, fumed silica particles obtained by burning silicon tetrachloride, dry-process silica particles such as arc process silica obtained by atomizing silica in a gas phase by high energy such as plasma, precipitated silica synthesized under an alkaline condition using a sodium silicate aqueous solution as a raw material, wet-process silica particles such as gel process silica synthesized under an acidic condition, colloidal silica particles obtained by making acidic silicic acid alkaline and polymerizing the acidic silicic acid, and sol-gel process silica particles obtained by hydrolyzing an organosilane compound.

As the silica particles serving as the external additive, commercially available hydrophobized silica particles may be used, or non-hydrophobized silica particles may be subjected to a treatment before use.

The titanium oxide particles as the external additive may be anatase-type titanium oxide particles or rutile-type titanium oxide particles. As a method of producing rutile-type titanium oxide particles, for example, there is a method described in JP 2001-26423 A, that is, a method in which an aqueous solution of titanium tetrachloride is hydrolyzed to prepare a fine titania sol having a rutile nucleus, and the sol is separated and then heat-treated to obtain titanium oxide particles. As a method of producing anatase-type titanium oxide particles, for example, there is a method described in JP 2000-10335 A, that is, a method in which a solution obtained by dissolving a raw material such as ilmenite ore in sulfuric acid is hydrolyzed, granulated, dried, and then calcined at a high temperature to obtain titanium oxide particles.

The content of the external additive is preferably 1 part by mass or more and 5 parts by mass or less relative to 100 parts by mass of the toner particles. When the content of the external additive is less than the lower limit, it is difficult to impart the effect of enhancing fluidity. When the content of the external additive exceeds the upper limit, there is a concern that fixability may decrease.

Examples of a method for adding the external additive to the toner particles include a method in which the toner particles and the external additive are mixed with an air flow mixer such as a Henschel mixer.

### Examples

Hereinafter, the toner of the disclosure will be specifically described on the basis of Examples and Comparative Examples.

### 1. Measurement Method

### Measurement Method of Volume-Average Particle Size of Toner Particles

To 50 mL of an electrolytic solution (available from Beckman Coulter, K.K., trade name: ISOTON-II), 20 mg of toner particles and 1 mL of a sodium alkyl ether sulfate are added. The mixture is treated by dispersion at a frequency of 20 kHz for 3 minutes using an ultrasonic disperser (available from As One Corporation, Desktop Dual Frequency Ultrasonic Cleaner, model: VS-D100) to prepare a measurement sample. The resulting measurement sample is measured using a particle size distribution measuring device (available from Beckman Coulter, K.K., model: Multisizer 3) under conditions of an aperture size of 100 μm and the number of measurement particles of 50000 counts, and the volume-average particle size is determined from the volumetric particle size distribution of the toner particles.

### Measurement Method of Melting Temperature of Resin

Using a flow characteristics evaluation apparatus (flow tester, available from Shimadzu Corporation, model: CFT-100C), a load of 20 kgf/cm² (9.8×10⁵ Pa) is applied while heating 1 g of the measurement sample of the resin at a temperature rise rate of 6° C./min, the measurement sample is allowed to flow out from a die (nozzle opening diameter 1 mm, length 1 mm), and the temperature at which half the amount of the measurement sample flows out is taken as the melting temperature Tm [° C.] of the resin.

Measurement Method of Number-Average Particle Size of Metal Oxide Particles Circle-equivalent diameters (Heywood diameter: a diameter of a circle having the same area as a projected area of a primary particle) of 100 primary particles are determined using a scanning electron microscope (available from Hitachi, Ltd., model: S-4800), and the number-average value thereof is calculated and taken as the number-average particle size.

### Measurement Method of Hydrophobicity of Metal Oxide Particles

The hydrophobicity in the disclosure represents a scale [%] of wettability to methanol, and is determined by the following equation. In the following equation, V [ml] represents an amount of methanol required to wet the entire metal oxide particles (to precipitate the entire metal oxide particles) by adding methanol dropwise to 50 ml of distilled water to which 0.2 g of the metal oxide particles are added while stirring.

$$Hydrophobicity [ \% ] = \{ V / ( 50 + V ) \} \times 100$$

### Measurement Method of SP Value of Resin

The SP value of the resin (solubility parameter, unit: [(cal/cm³)^{1/2}]) was calculated by the method proposed by Fedors et al. (method described in Robert F. Fedors, “POLYMER ENGINEERING AND SCIENCE”, February 1994, Vol. 14, No. 2, p. 147 to 154).

### 2. Production of Toner Raw Material

### Production of Amorphous Polyester-Based Resin L

Into a four-necked flask having a capacity of 10 liters equipped with a thermometer, a stainless steel stirring rod, a falling condenser, and a nitrogen inlet tube, 100 parts by mass of raw material monomers whose components are constituted by parts by mole shown in Table 1 below, 0.5 parts by mass of tin (II) 2-ethylhexanoate as an esterification catalyst, and 0.05 parts by mass of gallic acid (3,4,5-trihydroxybenzoic acid) as an esterification promoter were placed, and the temperature was raised to 210° C. over 5 hours in a mantle heater in a nitrogen atmosphere. Thereafter, the reaction was performed at a pressure of 8.0 kPa until the melting temperature Tm shown in Table 1 was reached, thereby obtaining amorphous polyester-based resins L1 to L7.

Table 1 below summarizes types and blending proportions of raw material monomers, and physical properties of the obtained resins, for the amorphous polyester-based resins L1 to L7.

TABLE 1

| | | Sample name of amorphous polyester-based resin L | | | | | | |
|---|---|---|---|---|---|---|---|---|
| | | L1 | L2 | L3 | L4 | L5 | L6 | L7 |
| Raw | Bisphenol A - | 70 | 30 | 82 | 30 | 90 | 10 | 95 |
| material | propylene oxide | | | | | | | |
| monomer | adduct | | | | | | | |
| [parts by | Bisphenol A - | 30 | 70 | 18 | 70 | 10 | 90 | 5 |
| mole] | ethylene oxide adduct | | | | | | | |
| | Terephthalic acid | 85 | 85 | 85 | 79 | 86 | 79 | 97 |
| | Dodecenyl succinic | — | — | — | 5 | — | 5 | — |
| | anhydride | | | | | | | |
| | Trimellitic anhydride | — | — | — | — | — | — | — |
| Physical | Tm [° C.] | 100 | 100 | 100 | 100 | 100 | 100 | 100 |
| property | SP value | 11.16 | 11.00 | 11.20 | 10.88 | 11.24 | 10.80 | 11.33 |
| of resin | [(cal/cm\hat{ }3)\hat{ }0.5] | | | | | | | |

### Production of Amorphous Polyester-Based Resin H

In a four-necked flask having a capacity of 10 liters equipped with a thermometer, a stainless steel stirring rod, a falling condenser, and a nitrogen inlet tube, 100 parts by mass of raw material monomers whose components are constituted in parts by mole shown in Table 2 below, except for trimellitic anhydride, 0.5 parts by mass of tin (II) 2-ethylhexanoate as an esterification catalyst, and 0.05 parts by mass of gallic acid as an esterification promoter were placed, and the temperature was raised to 235° C. over 3 hours in a mantle heater in a nitrogen atmosphere, and after reaching 235° C., the temperature was held for 7 hours. Thereafter, the mixture was cooled to a temperature of 210° C., trimellitic anhydride was added thereto, the temperature was held at 210° C. for 1 hour, and a reaction was performed under reduced pressure at a pressure of 8.0 kPa, and then the reaction was performed until the melting temperature Tm shown in Table 2 was reached, thereby obtaining amorphous polyester-based resins H1 to H7.

Table 2 below summarizes types and blending proportions of raw material monomers, and physical properties of the obtained resins, for the amorphous polyester-based resins H1 to H7.

TABLE 2

| | | Sample name of amorphous polyester-based resin H | | | | | | |
|---|---|---|---|---|---|---|---|---|
| | | H1 | H2 | H3 | H4 | H5 | H6 | H7 |
| Raw | Bisphenol A - | 70 | 55 | 80 | 30 | 70 | 30 | 90 |
| material | propylene oxide | | | | | | | |
| monomer | adduct | | | | | | | |
| [parts by | Bisphenol A - | 30 | 45 | 20 | 70 | 30 | 70 | 10 |
| mole] | ethylene oxide | | | | | | | |
| | adduct | | | | | | | |
| | Terephthalic acid | 65 | 65 | 65 | 60 | 69 | 58 | 71 |
| | Dodecenyl | 4 | 4 | 4 | 10 | 1 | 14 | 1 |
| | succinic anhydride | | | | | | | |
| | Trimellitic | 15 | 15 | 15 | 15 | 15 | 15 | 15 |
| | anhydride | | | | | | | |
| Physical | Tm [° C.] | 140 | 140 | 140 | 140 | 140 | 140 | 140 |
| property | SP value | 11.16 | 11.00 | 11.20 | 10.88 | 11.24 | 10.80 | 11.33 |
| of resin | [(cal/cm\hat{ }3)\hat{ }0.5] | | | | | | | |

### Production of Crystalline Polyester-Based Resin C

In a four-necked flask having a capacity of 10 liters equipped with a nitrogen inlet tube, a dewatering tube, a stirrer, and a thermocouple, 100 parts by mass of raw material monomers whose components are constituted in parts by mole shown in Table 3 below and 0.2 parts by mass of tin (II) 2-ethylhexanoate as an esterification catalyst, and the temperature was raised from 130° C. to 200° C. over 10 hours in a nitrogen gas atmosphere, and the reaction was carried out at a temperature of 200° C. and a pressure of 8.0 kPa for 1 hour, thereby obtaining crystalline polyester-based resins C1 to C7.

Table 3 below summarizes types and blending proportions of raw material monomers, and physical properties of the obtained resins, for the crystalline polyester-based resins C1 to C7.

TABLE 3

| | | Sample name of crystalline polyester-based resin | | | | | | |
|---|---|---|---|---|---|---|---|---|
| | | C1 | C2 | C3 | C4 | C5 | C6 | C7 |
| Alcohol | 1,6-hexanediol | 10 | — | — | — | — | — | — |
| component | 1,9-nonanediol | — | — | 50 | 15 | 30 | 35 | 15 |
| [parts by mole] | 1,10-decanediol | 40 | 50 | — | 35 | 20 | 15 | 35 |
| Carboxylic | Sebacic acid | — | — | 50 | — | — | 50 | 50 |
| acid | Dodecanedioic acid | 50 | 50 | — | 50 | 50 | — | — |
| component | | | | | | | | |
| [parts by mole] | | | | | | | | |
| Physical | SP value | 9.58 | 9.51 | 9.65 | 9.43 | 9.36 | 9.73 | 9.83 |
| property of | [(cal/cm\hat{ }3)\hat{ }0.5] | | | | | | | |
| resin | | | | | | | | |

### Production of Needle-Shaped Titanium Oxide Particles

An aqueous solution of sodium hydroxide was added to metatitanic acid obtained by a sulfuric acid method, and the mixture was heated. The product after heating was sufficiently washed with pure water, and then hydrochloric acid was added to the product, followed by heating at the boiling point of hydrochloric acid. Then, the heated product was cooled and neutralized by adding a 1−N aqueous solution of sodium hydroxide until the pH reached 7. The obtained product was washed and dried to obtain rutile-type titanium oxide particles.

The obtained rutile-type titanium oxide particles and sodium pyrophosphate decahydrate (Na₄P₂O₇·10H₂O) were mixed using a vibration ball mill to obtain a mixture. The obtained mixture was calcined at 600° C. in an electric furnace. The obtained calcined product was put into pure water and heated. The calcined product after heating was washed with pure water to remove soluble salts, thereby obtaining needle-shaped titanium oxide particles.

100 parts by mass of the obtained needle-shaped titanium oxide particles were dispersed in 500 parts by mass of pure water, and an aqueous solution containing 0.5 parts by mass of sodium aluminate was added thereto to precipitate aluminum oxide (Al₂O₃) on the surfaces of the needle-shaped titanium oxide particles. After the treatment, 100 parts by mass of the needle-shaped titanium oxide particles were mixed with 500 parts by mass of toluene under stirring, and 18 parts by mass of n-octyltrimethoxysilane as a hydrophobizing agent was added thereto, followed by stirring for 2 hours. Next, toluene was distilled off by distillation under reduced pressure, and the residue was heated at 120° C. for 3 hours, and then the obtained product was crushed to obtain “titanium oxide 1” which was needle-shaped titanium oxide particles surface-treated with n-octyltrimethoxysilane.

In addition, as shown in Table 4 below, “titanium oxides 2 to 10” and “titanium oxides 12 to 17” were obtained by the same procedure as described above except that the temperature during calcining was changed to obtain needle-shaped titanium oxide particles having different number-average particle sizes, and the type and the number of parts of the hydrophobizing agent added were changed. Note that the particle size in Table 4 represents a number-average particle size.

TABLE 4

| | | | | Added | |
|---|---|---|---|---|---|
| | | | | number | |
| | Calcining | Particle | | of | |
| Sample | temperature | size | Hydrophobizing | parts | Hydrophobicity |
| name | [° C.] | [nm] | agent | [parts] | [%] |
| Titanium | 600° C. | 35 | N- | 18 | 70 |
| oxide 1 | | | octyltrimethoxysilane | | |
| Titanium | 400° C. | 20 | N- | 24 | 70 |
| oxide 2 | | | octyltrimethoxysilane | | |
| Titanium | 650° C. | 45 | N- | 16 | 70 |
| oxide 3 | | | octyltrimethoxysilane | | |
| Titanium | 800° C. | 60 | N- | 12 | 70 |
| oxide 4 | | | octyltrimethoxysilane | | |
| Titanium | 600° C. | 35 | N- | 20 | 70 |
| oxide 5 | | | hexyltrimethoxysilane | | |
| Titanium | 600° C. | 35 | N- | 16 | 70 |
| oxide 6 | | | decyltrimethoxysilane | | |
| Titanium | 600° C. | 35 | N- | 15 | 60 |
| oxide 7 | | | octyltrimethoxysilane | | |
| Titanium | 600° C. | 35 | N- | 21 | 75 |
| oxide 8 | | | octyltrimethoxysilane | | |
| Titanium | 600° C. | 35 | N- | 10 | 40 |
| oxide 9 | | | octyltrimethoxysilane | | |
| Titanium | 600° C. | 35 | N- | 24 | 80 |
| oxide 10 | | | octyltrimethoxysilane | | |
| Titanium | 600° C. | 35 | N- | 14 | 70 |
| oxide 12 | | | dodecyltrimethoxysilane | | |
| Titanium | 600° C. | 35 | N- | 8 | 35 |
| oxide 13 | | | octyltrimethoxysilane | | |
| Titanium | 600° C. | 35 | N- | 27 | 85 |
| oxide 14 | | | octyltrimethoxysilane | | |
| Titanium | 900° C. | 70 | N- | 10 | 70 |
| oxide 15 | | | octyltrimethoxysilane | | |
| Titanium | 600° C. | 35 | N- | 22 | 70 |
| oxide 16 | | | butyltrimethoxysilane | | |
| Titanium | 600° C. | 35 | i- | 18 | 70 |
| oxide 17 | | | octyltrimethoxysilane | | |

### Production of Spherical Titanium Oxide Particles

An aqueous solution of sodium hydroxide was added to metatitanic acid obtained by a sulfuric acid method, and the mixture was heated. The product after heating was sufficiently washed with pure water, and then hydrochloric acid was added to the product, followed by heating at the boiling point of hydrochloric acid. Then, the heated product was cooled and neutralized by adding a 1−N aqueous solution of sodium hydroxide until the pH reached 7. The obtained product was washed and dried to obtain spherical rutile-type titanium oxide particles.

100 parts by mass of the obtained spherical titanium oxide particles were dispersed in 500 parts by mass of pure water, and an aqueous solution containing 0.5 parts by mass of sodium aluminate was added thereto to precipitate aluminum oxide (Al₂O₃) on the surfaces of the spherical titanium oxide particles. After the treatment, 100 parts by mass of the spherical titanium oxide particles were mixed with 500 parts by mass of toluene under stirring, and 18 parts by mass of n-octyltrimethoxysilane as a hydrophobizing agent was added thereto, followed by stirring for 2 hours. Next, toluene was distilled off by distillation under reduced pressure, and the residue was heated at 120° C. for 3 hours, and then the obtained product was crushed to obtain “titanium oxide 11” which was spherical titanium oxide particles surface-treated with n-octyltrimethoxysilane.

### Production of Alumina Particles

Bauxite was used as a raw material, and aluminum oxide was purified by the Bayer process. Sodium hydroxide was added to bauxite, and was heated and dissolved at 250° C. The insoluble content was removed by filtration, and the aluminum hydroxide was recovered as a solid by cooling. The aluminum hydroxide was heated and dehydrated at 1050° C. to obtain alumina. Next, the obtained alumina was dispersed in toluene, and then crushed using a bead mill (available from Aimex Co., Ltd., NVM-2 type) and beads having a diameter of 0.5 mm to obtain alumina particles.

100 parts by mass of the obtained alumina particles were mixed with 500 parts by mass of toluene under stirring, and 18 parts by mass of n-octyltrimethoxysilane as a hydrophobizing agent was added thereto, followed by stirring for 2 hours. Next, toluene was distilled off by distillation under reduced pressure, and the residue was heated at 120° C. for 3 hours, and then the obtained product was crushed to obtain “alumina 1” which was alumina particles surface-treated with n-octyltrimethoxysilane.

Table 5 below shows a list of metal oxide particles used in Examples and Comparative Examples. Note that the particle size in Table 5 represents a number-average particle size.

TABLE 5

| | | | Particle | | |
|---|---|---|---|---|---|
| Sample | Base | | size | Hydrophobicity | Particle |
| name | body | Surface treatment agent | [nm] | [%] | shape |
| Titanium | Titanium | N-octyltrimethoxysilane | 35 | 70 | Needle- |
| oxide 1 | oxide | | | | shaped |
| Titanium | Titanium | N-octyltrimethoxysilane | 20 | 70 | Needle- |
| oxide 2 | oxide | | | | shaped |
| Titanium | Titanium | N-octyltrimethoxysilane | 45 | 70 | Needle- |
| oxide 3 | oxide | | | | shaped |
| Titanium | Titanium | N-octyltrimethoxysilane | 60 | 70 | Needle- |
| oxide 4 | oxide | | | | shaped |
| Titanium | Titanium | N-hexyltrimethoxysilane | 35 | 70 | Needle- |
| oxide 5 | oxide | | | | shaped |
| Titanium | Titanium | N-decyltrimethoxysilane | 35 | 70 | Needle- |
| oxide 6 | oxide | | | | shaped |
| Titanium | Titanium | N-octyltrimethoxysilane | 35 | 60 | Needle- |
| oxide 7 | oxide | | | | shaped |
| Titanium | Titanium | N-octyltrimethoxysilane | 35 | 75 | Needle- |
| oxide 8 | oxide | | | | shaped |
| Titanium | Titanium | N-octyltrimethoxysilane | 35 | 40 | Needle- |
| oxide 9 | oxide | | | | shaped |
| Titanium | Titanium | N-octyltrimethoxysilane | 35 | 80 | Needle- |
| oxide 10 | oxide | | | | shaped |
| Titanium | Titanium | N-octyltrimethoxysilane | 35 | 70 | Spherical |
| oxide 11 | oxide | | | | |
| Titanium | Titanium | N- | 35 | 70 | Needle- |
| oxide 12 | oxide | dodecyltrimethoxysilane | | | shaped |
| Titanium | Titanium | N-octyltrimethoxysilane | 35 | 35 | Needle- |
| oxide 13 | oxide | | | | shaped |
| Titanium | Titanium | N-octyltrimethoxysilane | 35 | 85 | Needle- |
| oxide 14 | oxide | | | | shaped |
| Titanium | Titanium | N-octyltrimethoxysilane | 70 | 70 | Needle- |
| oxide 15 | oxide | | | | shaped |
| Titanium | Titanium | N-butyltrimethoxysilane | 35 | 70 | Needle- |
| oxide 16 | oxide | | | | shaped |
| Titanium | Titanium | i-octyltrimethoxysilane | 35 | 70 | Needle- |
| oxide 17 | oxide | | | | shaped |
| Alumina 1 | Alumina | N-octyltrimethoxysilane | 40 | 70 | Spherical |

### 3. Production of Toner and Two-Component Developer

### Example 1

### Material Mixing, Kneading, Pulverizing, and Classifying Steps

### Binder Resin

Amorphous polyester-based resin L1: 39.2 mass %
Amorphous polyester-based resin H1: 39.2 mass %

### Crystalline Resin

Crystalline polyester-based resin C1: 5.0 mass %

### Colorant

Carbon black (available from Cabot Corporation, trade name: Regal 330): 6 mass %

### Release Agent

Ester wax (available from NOF Corporation, trade name: WEP-3): 3 mass %

### Release Agent

Styrene-acrylic copolymer (available from Mitsui Chemicals, Inc., trade name: SA800): 5 mass %

### Charge Control Agent

Salicylic acid-based compound (available from Orient Chemical Industries Co., Ltd., trade name: Bontron E-84), 2 mass %

### Metal Oxide Particles

Titanium oxide 1: 0.6 mass %

The above-mentioned toner raw materials were premixed for 5 minutes using a Henschel mixer (available from Nippon Coke & Engineering Co., Ltd., model: FM20C) and then melt-kneaded using a twin-screw extruder to obtain a melt-kneaded product. The conditions for melt-kneading by the twin-screw extruder were set as follows: cylinder set temperature: 110° C., barrel rotation speed: 300 rpm, and raw material feeding rate: 20 kg/hour.

The obtained melt-kneaded product was cooled using a cooling belt, coarsely pulverized by a cutting mill, finely pulverized by a jet pulverizer, and classified by an air classifier to obtain toner particles having a volume-average particle size of 6.5 μm.

### External Addition Step

Next, 1.0 parts by mass of a first external additive (available from Cabot Corporation, trade name: TG-C190, silica particles having a primary average particle size of 115 nm) and 1.5 parts by mass of a second external additive (available from Nippon Aerosil Co., Ltd., trade name: R974, silica particles having a primary average particle size of 12 nm) were added as external additives to 100 parts by mass of the obtained toner particles, and the mixture was stirred with a Henschel mixer (available from Nippon Coke & Engineering Co., Ltd., model: FM20C) to obtain a toner having a volume-average particle size of 6.5 μm.

### Production of Two-component Developer

The obtained toner and ferrite core carriers having a volume-average particle size of 40 μm were mixed while adjusting the concentration of the toner with respect to the total amount of the two-component developer to 7%, thereby obtaining a two-component developer having a toner concentration of 7%.

### Examples 2 to 39 and Comparative Examples 1 to 5

Toners and two-component developers were obtained in the same manner as in Example 1 except that the types and contents of the constituent components of the toner raw materials were changed as shown in Tables 6 and 7 below. Note that in each of Examples 2 to 39 and Comparative Examples 1 to 5, the blending ratio of the amorphous polyester-based resin L to the amorphous polyester-based resin H was 1: 1 as in Example 1. The paraffin wax in Example 39 in Table 6 is trade name “HNP-10PD” available from Nippon Seiro Co., Ltd.

TABLE 6

| | Amorphous | | Crystalline polyester | | | |
|---|---|---|---|---|---|---|
| | polyester | | | | Content | |
| | Sample | SP | Sample | SP | B | Ester wax |
| | name | value | name | value | [wt. %] | Type |
| Example 1 | L1 + H1 | 11.16 | C1 | 9.58 | 5.0 | Ester |
| Example 2 | L1 + H1 | 11.16 | C1 | 9.58 | 5.0 | Ester |
| Example 3 | L1 + H1 | 11.16 | C1 | 9.58 | 5.0 | Ester |
| Example 4 | L1 + H1 | 11.16 | C1 | 9.58 | 5.0 | Ester |
| Example 5 | L1 + H1 | 11.16 | C1 | 9.58 | 5.0 | Ester |
| Example 6 | L1 + H1 | 11.16 | C1 | 9.58 | 5.0 | Ester |
| Example 7 | L1 + H1 | 11.16 | C1 | 9.58 | 4.5 | Ester |
| Example 8 | L1 + H1 | 11.16 | C1 | 9.58 | 5.0 | Ester |
| Example 9 | L1 + H1 | 11.16 | C1 | 9.58 | 5.0 | Ester |
| Example 10 | L1 + H1 | 11.16 | C1 | 9.58 | 8.0 | Ester |
| Example 11 | L1 + H1 | 11.16 | C1 | 9.58 | 5.0 | Ester |
| Example 12 | L1 + H1 | 11.16 | C1 | 9.58 | 5.0 | Ester |
| Example 13 | L1 + H1 | 11.16 | C1 | 9.58 | 5.0 | Ester |
| Example 14 | L1 + H1 | 11.16 | C1 | 9.58 | 5.0 | Ester |
| Example 15 | L1 + H1 | 11.16 | C1 | 9.58 | 5.0 | Ester |
| Example 16 | L2 + H2 | 11.10 | C1 | 9.58 | 5.0 | Ester |
| Example 17 | L3 + H3 | 11.20 | C1 | 9.58 | 5.0 | Ester |
| Example 18 | L4 + H4 | 10.88 | C1 | 9.58 | 5.0 | Ester |
| Example 19 | L5 + H5 | 11.24 | C1 | 9.58 | 5.0 | Ester |
| Example 20 | L1 + H1 | 11.16 | C2 | 9.51 | 5.0 | Ester |
| Example 21 | L1 + H1 | 11.16 | C3 | 9.65 | 5.0 | Ester |
| Example 22 | L1 + H1 | 11.16 | C4 | 9.43 | 5.0 | Ester |
| Example 23 | L1 + H1 | 11.16 | C5 | 9.73 | 5.0 | Ester |
| Example 24 | L1 + H1 | 11.16 | C1 | 9.58 | 6.0 | Ester |
| Example 25 | L1 + H1 | 11.16 | C1 | 9.58 | 5.0 | Ester |
| Example 26 | L1 + H1 | 11.16 | C1 | 9.58 | 8.0 | Ester |
| Example 27 | L1 + H1 | 11.16 | C1 | 9.58 | 5.0 | Ester |
| Example 28 | L1 + H1 | 11.16 | C1 | 9.58 | 5.0 | Ester |
| Example 29 | L1 + H1 | 11.16 | C1 | 9.58 | 5.0 | Ester |
| Example 30 | L1 + H1 | 11.16 | C1 | 9.58 | 5.0 | Ester |
| Example 31 | L1 + H1 | 11.16 | C1 | 9.58 | 5.0 | Ester |
| Example 32 | L1 + H1 | 11.16 | C1 | 9.58 | 5.0 | Ester |
| Example 33 | L6 + H6 | 10.80 | C1 | 9.58 | 5.0 | Ester |
| Example 34 | L7 + H7 | 11.33 | C1 | 9.58 | 5.0 | Ester |
| Example 35 | L1 + H1 | 11.16 | C6 | 9.36 | 5.0 | Ester |
| Example 36 | L1 + H1 | 11.16 | C7 | 9.83 | 5.0 | Ester |
| Example 37 | L1 + H1 | 11.16 | C1 | 9.58 | 10.0 | Ester |
| Example 38 | L1 + H1 | 11.16 | C1 | 9.58 | 4.0 | Ester |
| Example 39 | L1 + H1 | 11.16 | C1 | 9.58 | 5.0 | Paraffin |
| Comparative | L1 + H1 | 11.16 | C1 | 9.58 | 5.0 | Ester |
| Example 1 | | | | | | |
| Comparative | L1 + H1 | 11.16 | C1 | 9.58 | 5.0 | Ester |
| Example 2 | | | | | | |
| Comparative | L1 + H1 | 11.16 | C1 | 9.58 | 5.0 | Ester |
| Example 3 | | | | | | |
| Comparative | L1 + H1 | 11.16 | C1 | 9.58 | 5.0 | Ester |
| Example 4 | | | | | | |
| Comparative | L1 + H1 | 11.16 | C1 | 9.58 | 8.0 | Ester |
| Example 5 | | | | | | |

TABLE 7

| | Metal oxide particles | | | | | | | |
|---|---|---|---|---|---|---|---|---|
| | | Alkyl group of | | | | | | |
| | | hydrophobizing | | | | | | |
| | | agent | | Particle | Content | | | Mass |
| | Sample | Carbon | | size | A | Hydrophobicity | | ratio |
| | name | number | Structure | [nm] | [wt. %] | [%] | Shape | A/B |
| Example 1 | Titanium | 8 | Linear | 35 | 0.06 | 70 | Needle- | 0.012 |
| | oxide 1 | | chain | | | | shaped | |
| Example 2 | Titanium | 8 | Linear | 20 | 0.06 | 70 | Needle- | 0.012 |
| | oxide 2 | | chain | | | | shaped | |
| Example 3 | Titanium | 8 | Linear | 45 | 0.06 | 70 | Needle- | 0.012 |
| | oxide 3 | | chain | | | | shaped | |
| Example 4 | Titanium | 8 | Linear | 60 | 0.06 | 70 | Needle- | 0.012 |
| | oxide 4 | | chain | | | | shaped | |
| Example 5 | Titanium | 6 | Linear | 35 | 0.06 | 70 | Needle- | 0.012 |
| | oxide 5 | | chain | | | | shaped | |
| Example 6 | Titanium | 8 | Linear | 35 | 0.50 | 70 | Needle- | 0.100 |
| | oxide 1 | | chain | | | | shaped | |
| Example 7 | Titanium | 8 | Linear | 35 | 0.03 | 70 | Needle- | 0.007 |
| | oxide 1 | | chain | | | | shaped | |
| Example 8 | Titanium | 8 | Linear | 35 | 0.10 | 70 | Needle- | 0.020 |
| | oxide 1 | | chain | | | | shaped | |
| Example 9 | Titanium | 8 | Linear | 35 | 0.02 | 70 | Needle- | 0.004 |
| | oxide 1 | | chain | | | | shaped | |
| Example | Titanium | 8 | Linear | 35 | 2.00 | 70 | Needle- | 0.250 |
| 10 | oxide 1 | | chain | | | | shaped | |
| Example | Titanium | 10 | Linear | 35 | 0.06 | 70 | Needle- | 0.012 |
| 11 | oxide 6 | | chain | | | | shaped | |
| Example | Titanium | 8 | Linear | 35 | 0.06 | 60 | Needle- | 0.012 |
| 12 | oxide 7 | | chain | | | | shaped | |
| Example | Titanium | 8 | Linear | 35 | 0.06 | 75 | Needle- | 0.012 |
| 13 | oxide 8 | | chain | | | | shaped | |
| Example | Titanium | 8 | Linear | 35 | 0.06 | 40 | Needle- | 0.012 |
| 14 | oxide 9 | | chain | | | | shaped | |
| Example | Titanium | 8 | Linear | 35 | 0.06 | 80 | Needle- | 0.012 |
| 15 | oxide 10 | | chain | | | | shaped | |
| Example | Titanium | 8 | Linear | 35 | 0.06 | 70 | Needle- | 0.012 |
| 16 | oxide 1 | | chain | | | | shaped | |
| Example | Titanium | 8 | Linear | 35 | 0.06 | 70 | Needle- | 0.012 |
| 17 | oxide 1 | | chain | | | | shaped | |
| Example | Titanium | 8 | Linear | 35 | 0.06 | 70 | Needle- | 0.012 |
| 18 | oxide 1 | | chain | | | | shaped | |
| Example | Titanium | 8 | Linear | 35 | 0.06 | 70 | Needle- | 0.012 |
| 19 | oxide 1 | | chain | | | | shaped | |
| Example | Titanium | 8 | Linear | 35 | 0.06 | 70 | Needle- | 0.012 |
| 20 | oxide 1 | | chain | | | | shaped | |
| Example | Titanium | 8 | Linear | 35 | 0.06 | 70 | Needle- | 0.012 |
| 21 | oxide 1 | | chain | | | | shaped | |
| Example | Titanium | 8 | Linear | 35 | 0.06 | 70 | Needle- | 0.012 |
| 22 | oxide 1 | | chain | | | | shaped | |
| Example | Titanium | 8 | Linear | 35 | 0.06 | 70 | Needle- | 0.012 |
| 23 | oxide 1 | | chain | | | | shaped | |
| Example | Titanium | 8 | Linear | 35 | 0.03 | 70 | Needle- | 0.005 |
| 24 | oxide 1 | | chain | | | | shaped | |
| Example | Titanium | 8 | Linear | 35 | 0.25 | 70 | Needle- | 0.050 |
| 25 | oxide 1 | | chain | | | | shaped | |
| Example | Titanium | 8 | Linear | 35 | 0.02 | 70 | Needle- | 0.003 |
| 26 | oxide 1 | | chain | | | | shaped | |
| Example | Titanium | 8 | Linear | 35 | 2.00 | 70 | Needle- | 0.400 |
| 27 | oxide 1 | | chain | | | | shaped | |
| Example | Alumina | 8 | Linear | 40 | 0.06 | 70 | Spherical | 0.012 |
| 28 | 1 | | chain | | | | | |
| Example | Titanium | 8 | Linear | 35 | 0.06 | 70 | Spherical | 0.012 |
| 29 | oxide 11 | | chain | | | | | |
| Example | Titanium | 12 | Linear | 35 | 0.06 | 70 | Needle- | 0.012 |
| 30 | oxide 12 | | chain | | | | shaped | |
| Example | Titanium | 8 | Linear | 35 | 0.06 | 35 | Needle- | 0.012 |
| 31 | oxide 13 | | chain | | | | shaped | |
| Example | Titanium | 8 | Linear | 35 | 0.06 | 85 | Needle- | 0.012 |
| 32 | oxide 14 | | chain | | | | shaped | |
| Example | Titanium | 8 | Linear | 35 | 0.06 | 70 | Needle- | 0.012 |
| 33 | oxide 1 | | chain | | | | shaped | |
| Example | Titanium | 8 | Linear | 35 | 0.06 | 70 | Needle- | 0.012 |
| 34 | oxide 1 | | chain | | | | shaped | |
| Example | Titanium | 8 | Linear | 35 | 0.06 | 70 | Needle- | 0.012 |
| 35 | oxide 1 | | chain | | | | shaped | |
| Example | Titanium | 8 | Linear | 35 | 0.06 | 70 | Needle- | 0.012 |
| 36 | oxide 1 | | chain | | | | shaped | |
| Example | Titanium | 8 | Linear | 35 | 0.02 | 70 | Needle- | 0.002 |
| 37 | oxide 1 | | chain | | | | shaped | |
| Example | Titanium | 8 | Linear | 35 | 2.00 | 70 | Needle- | 0.500 |
| 38 | oxide 1 | | chain | | | | shaped | |
| Example | Titanium | 8 | Linear | 35 | 0.06 | 70 | Needle- | 0.012 |
| 39 | oxide 1 | | chain | | | | shaped | |
| Comparative | Titanium | 8 | Linear | 70 | 0.06 | 70 | Needle- | 0.012 |
| Example 1 | oxide 15 | | chain | | | | shaped | |
| Comparative | Titanium | 4 | Linear | 35 | 0.06 | 70 | Needle- | 0.012 |
| Example 2 | oxide 16 | | chain | | | | shaped | |
| Comparative | Titanium | 8 | Branched | 35 | 0.06 | 70 | Needle- | 0.012 |
| Example 3 | oxide 17 | | | | | | shaped | |
| Comparative | Titanium | 8 | Linear | 35 | 0.01 | 70 | Needle- | 0.002 |
| Example 4 | oxide 1 | | chain | | | | shaped | |
| Comparative | Titanium | 8 | Linear | 35 | 2.50 | 70 | Needle- | 0.313 |
| Example 5 | oxide 1 | | chain | | | | shaped | |

### 4. Evaluation

### Evaluation Item 1: Evaluation of Hot Offset Resistance

A fixed image was formed with a two-component developer using a color multifunction machine (available from Sharp Corporation, model: BP-70C55) modified for evaluation. First, a sample image including a solid image (a rectangle 20 mm long and 50 mm wide) was formed as an unfixed image on a A4 size recording sheet (available from Sharp Corporation, model: PP117WA4). At this time, the adhesion amount of the toner to the recording sheet in the solid image was adjusted to 0.5 mg/cm².

Next, a fixed image was prepared using a belt fixing device. The fixing process speed was set to 140 mm/see, and the temperature of the fixing belt was raised from 150° C. in increments of 5° C. to determine the highest temperature at which hot offset did not occur. Note that “hot offset” means that the toner is not fixed to the recording paper at the time of fixing but remains attached to the fixing belt, and adheres to the recording paper after the fixing belt makes one round. From the obtained results, the “hot offset resistance” was evaluated according to the following criteria.
⊚ (Excellent): The highest temperature is 195° C. or higher.
◯ (Good): The highest temperature is 190° C. or higher and lower than 195° C.
Δ (Fair): The highest temperature is 185° C. or higher and lower than 190° C.
x (Poor): The highest temperature is lower than 185° C.

### Evaluation Item 2: Evaluation of Uniformity of Image Density

The developer and the toner thus prepared were filled in a developing device and a toner cartridge of a color multifunction machine (available from Sharp Corporation, model: BP-70C55), respectively. Next, a continuous print test was performed on 50000 of A4 size recording sheets (available from Sharp Corporation, model: PP117WA4) under the conditions of a temperature of 25° C. and a relative humidity of 5% in such a manner that square solid images (ID=1.45 to 1.50) each having one side of 10 mm were formed at three positions, i.e., the central portion and both end portions in the axial direction of the developing roller. An image density was measured at arbitrary 10 locations on the 50000th print sample, and a standard deviation was calculated from the measured image densities. A larger standard deviation indicates a lower uniformity. Based on the calculated standard deviation, evaluation was made according to the following criteria.
⊚ (Excellent): The standard deviation is less than 0.1.
◯ (Good): The standard deviation is 0.1 or more and less than 0.2.
Δ (Fair): The standard deviation is 0.2 or more and less than 0.4.
x (Poor): The standard deviation is 0.4 or more.

### Evaluation Item 3: Evaluation Method of Fogging

The developer and the toner thus prepared were filled in a developing device and a toner cartridge of a color multifunction machine (available from Sharp Corporation, model: BP-70C55), respectively. A continuous print test was performed on 50000 of A4 size recording sheets (available from Sharp Corporation, model: PP117WA4) under the conditions of a temperature of 25° C. and a relative humidity of 5% to form an image in which 10% of the printable area of the recording sheet was filled with the toner. A brightness of a specific portion of the image that was not filled was measured for the 50000th print sample using a colorimeter (available from Nippon Denshoku Industries Co., Ltd., model: ZE6000). The difference between this brightness and the brightness before printing measured in advance was defined as a fogging value. Based on the measured fogging value, evaluation was made according to the following criteria.
⊚ (Excellent): The fogging value is less than 1.4.
◯ (Good): The fogging value is 1.4 or more and less than 1.7.
Δ (Fair): The fogging value is 1.7 or more and less than 2.0.
x (Poor): The fogging value is 2.0 or more.

TABLE 8

| | Hot offset resistance | | | | | |
|---|---|---|---|---|---|---|
| | Highest | | Image density uniformity | | Fogging | |
| | temperature | | Standard | | Fogging | |
| | [° C.] | Evaluation | deviation | Evaluation | value | Evaluation |
| Example 1 | 200 | ⊚ | 0.06 | ⊚ | 0.7 | ⊚ |
| Example 2 | 200 | ⊚ | 0.07 | ⊚ | 0.9 | ⊚ |
| Example 3 | 200 | ⊚ | 0.07 | ⊚ | 1.2 | ⊚ |
| Example 4 | 200 | ⊚ | 0.07 | ⊚ | 1.5 | ◯ |
| Example 5 | 190 | ◯ | 0.16 | ◯ | 1.6 | ◯ |
| Example 6 | 200 | ⊚ | 0.06 | ⊚ | 1.4 | ⊚ |
| Example 7 | 195 | ⊚ | 0.08 | ⊚ | 0.8 | ⊚ |
| Example 8 | 200 | ⊚ | 0.07 | ⊚ | 1.0 | ⊚ |
| Example 9 | 190 | ◯ | 0.18 | ◯ | 1.0 | ⊚ |
| Example 10 | 200 | ⊚ | 0.07 | ⊚ | 1.6 | ◯ |
| Example 11 | 190 | ◯ | 0.13 | ◯ | 1.1 | ⊚ |
| Example 12 | 200 | ⊚ | 0.07 | ⊚ | 1.3 | ⊚ |
| Example 13 | 200 | ⊚ | 0.07 | ⊚ | 1.2 | ⊚ |
| Example 14 | 195 | ⊚ | 0.10 | ◯ | 1.5 | ◯ |
| Example 15 | 200 | ⊚ | 0.06 | ⊚ | 1.4 | ◯ |
| Example 16 | 200 | ⊚ | 0.09 | ⊚ | 0.9 | ⊚ |
| Example 17 | 195 | ⊚ | 0.08 | ⊚ | 0.9 | ⊚ |
| Example 18 | 195 | ⊚ | 0.15 | ◯ | 1.0 | ⊚ |
| Example 19 | 190 | ◯ | 0.11 | ◯ | 0.9 | ⊚ |
| Example 20 | 195 | ⊚ | 0.07 | ⊚ | 0.8 | ⊚ |
| Example 21 | 200 | ⊚ | 0.09 | ⊚ | 0.8 | ⊚ |
| Example 22 | 190 | ◯ | 0.12 | ◯ | 1.2 | ⊚ |
| Example 23 | 195 | ⊚ | 0.16 | ◯ | 0.8 | ⊚ |
| Example 24 | 200 | ⊚ | 0.09 | ⊚ | 0.8 | ⊚ |
| Example 25 | 200 | ⊚ | 0.08 | ⊚ | 1.1 | ⊚ |
| Example 26 | 190 | ◯ | 0.18 | ◯ | 1.3 | ⊚ |
| Example 27 | 190 | ◯ | 0.08 | ⊚ | 1.6 | ◯ |
| Example 28 | 190 | ◯ | 0.07 | ⊚ | 1.8 | Δ |
| Example 29 | 190 | ◯ | 0.09 | ⊚ | 1.7 | Δ |
| Example 30 | 185 | Δ | 0.08 | ⊚ | 1.8 | Δ |
| Example 31 | 195 | ⊚ | 0.10 | ◯ | 1.9 | Δ |
| Example 32 | 200 | ⊚ | 0.06 | ⊚ | 1.7 | Δ |
| Example 33 | 195 | ⊚ | 0.23 | Δ | 1.1 | ⊚ |
| Example 34 | 185 | Δ | 0.13 | ◯ | 0.9 | ⊚ |
| Example 35 | 185 | Δ | 0.15 | ◯ | 1.3 | ⊚ |
| Example 36 | 195 | ⊚ | 0.25 | Δ | 1.0 | ⊚ |
| Example 37 | 185 | Δ | 0.30 | Δ | 1.1 | ⊚ |
| Example 38 | 185 | Δ | 0.35 | Δ | 1.9 | Δ |
| Example 39 | 195 | ⊚ | 0.14 | ◯ | 1.8 | Δ |
| Comparative | 195 | ⊚ | 0.07 | ⊚ | 2.4 | X |
| Example 1 | | | | | | |
| Comparative | 180 | X | 0.45 | X | 1.5 | ◯ |
| Example 2 | | | | | | |
| Comparative | 180 | X | 0.42 | X | 1.2 | ⊚ |
| Example 3 | | | | | | |
| Comparative | 180 | X | 0.41 | X | 2.3 | X |
| Example 4 | | | | | | |
| Comparative | 195 | ⊚ | 0.16 | ◯ | 2.5 | X |
| Example 5 | | | | | | |

Table 8 shows the evaluation results of Examples and Comparative Examples. As is clear from Table 8, the toners of Examples 1 to 39, which are toners having toner particles containing an amorphous polyester-based resin, a crystalline polyester-based resin, and a wax, wherein the toner particles contain metal oxide particles having a number-average particle size of 60 nm or less, the metal oxide particles are surface-treated with a hydrophobizing agent containing a linear alkyl group having 6 or more carbon atoms, and the content of the metal oxide particles in the toner particles is 0.02 mass % or more and 2 mass % or less, have sufficient hot offset resistance and can suppress the occurrence of fogging and a decrease in uniformity of an image density over a long period of time.

On the other hand, in Comparative Examples 1 to 5 in which these requirements were not satisfied, the evaluation results of at least one of the three evaluation items were inferior to those of Examples. Note that Comparative Example 1 is an example in which the number-average particle size of the metal oxide particles does not satisfy the above requirement, Comparative Example 2 is an example in which the number of carbon atoms of the linear alkyl group contained in the hydrophobizing agent does not satisfy the above requirement, Comparative Example 3 is an example in which the alkyl group contained in the hydrophobizing agent is not linear, and Comparative Examples 4 and 5 are examples in which the content of the metal oxide particles in the toner particles does not satisfy the above requirement.

It is found that Example 1 using titanium oxide particles as the metal oxide particles is superior to Example 28 using alumina particles in the evaluation of the hot offset resistance and the fogging, and particularly superior in the evaluation of the fogging.

It is found that Example 1 in which the titanium oxide particles as the metal oxide particles each have a needle shape is superior to Example 29 in which the titanium oxide particles each have a spherical shape in the evaluation of the hot offset resistance and the fogging, and is particularly superior in the evaluation of the fogging.

It is found that Examples 1 and 11 in which the number of carbon atoms of the linear alkyl group contained in the hydrophobizing agent is 10 or less is particularly excellent in the evaluation of the hot offset resistance and the fogging as compared with Example 30 in which the number of carbon atoms exceeds the upper limit.

It is found that Examples 1 and 14 in which the hydrophobicity of the metal oxide particles is 40% or more is particularly excellent in the evaluation of the fogging as compared with Example 31 in which the hydrophobicity of the metal oxide particles is less than the lower limit. In addition, it is found that Examples 1 and 15 in which the hydrophobicity of the metal oxide particles is 80% or less is particularly excellent in the evaluation of the fogging as compared with Example 32 in which the hydrophobicity of the metal oxide particles exceeds the upper limit.

It is found that Examples 1 and 18 in which the SP value of the amorphous polyester-based resin is 10.85 or more is particularly excellent in the evaluation of the uniformity of the image density as compared with Example 33 in which the SP value of the amorphous polyester-based resin is less than the lower limit. In addition, it is found that Examples 1 and 19 in which the SP value of the amorphous polyester-based resin is 11.3 or less is particularly excellent in the evaluation of the hot offset resistance as compared with Example 34 in which the SP value of the amorphous polyester-based resin exceeds the upper limit.

It is found that, when the content of the metal oxide particles in the toner particles is defined as A mass % and the content of the crystalline polyester-based resin in the toner particles is defined as B mass %, Examples 1 and 26 in which the mass ratio A/B is 0.003 or more is particularly excellent in the evaluation of the hot offset resistance and the uniformity of the image density as compared with Example 37 in which the mass ratio A/B is less than the lower limit. It is found that Examples 1 and 27 in which the mass ratio A/B is 0.4 or more is superior to Example 38 in which the mass ratio A/B exceeds the upper limit in the evaluation of all the three evaluation items.

It is found that Example 1 using an ester wax as the wax is superior to Example 39 using a paraffin wax in the evaluation of the uniformity of the image density and the fogging, and is particularly superior in the evaluation of the fogging.

The embodiments disclosed herein are illustrative in all respects and are not the basis for a limited interpretation. Accordingly, the technical scope of the disclosure is not to be construed by the foregoing embodiments only, and is defined based on the description of the claims. In addition, meanings equivalent to the range of the claims and all changes made within the range are included.

### REFERENCE SIGNS LIST

1 Toner particle
11 Amorphous polyester-based resin
12 Crystalline polyester-based resin
12a Crystalline portion
12b Amorphous portion
13 Wax
14 Metal oxide particle surface-treated with hydrophobizing agent
14a Base body (metal oxide particle main body)
14b Hydrophobizing agent

1. A toner comprising toner particles comprising an amorphous polyester-based resin, a crystalline polyester-based resin, and a wax, wherein
the toner particles include metal oxide particles having a number-average particle size of 60 nm or less,
the metal oxide particles are surface-treated with a hydrophobizing agent containing a linear alkyl group having 6 or more carbon atoms, and
a content of the metal oxide particles in the toner particles is 0.02 mass % or more and 2 mass % or less.

2. The toner according to claim 1, wherein
the metal oxide particles are titanium oxide particles.

3. The toner according to claim 1, wherein
a shape of each of the metal oxide particles is a needle shape.

4. The toner according to claim 1, wherein
the linear alkyl group contained in the hydrophobizing agent has 10 or less carbon atoms.

5. The toner according to claim 1, wherein
a hydrophobicity of the metal oxide particles is 40% or more and 80% or less.

6. The toner according to claim 1, wherein
the amorphous polyester-based resin has an SP value of 10.85 or more and 11.3 or less, and
the crystalline polyester-based resin has an SP value of 9.4 or more and 9.8 or less.

7. The toner according to claim 1, wherein
when the content of the metal oxide particles in the toner particles is defined as A mass % and a content of the crystalline polyester-based resin in the toner particles is defined as B mass %, a mass ratio A/B is 0.003 or more and 0.4 or less.

8. The toner according to claim 1, wherein
the wax is an ester wax.
